(19) United States
(12) Patent Application Publication
(10) Pub. No.: US 2005/0240314 A1
(43) Pub. Date: Oct. 27, 2005

(54) Method and apparatus for controlling and monitoring electrical power consumption

(76) Inventor: Edwin Alberto Martinez, Santo Domingo (DO)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 11/086,687

(22) Filed: Mar. 22, 2005

Related U.S. Application Data
(63) Continuation of application No. 10/916,174, filed on Aug. 11, 2004.

(30) Foreign Application Priority Data
Apr. 27, 2004 (DO) P-2004/27/04/01

(51) Int. Cl. G06F 19/00

(52) U.S. Cl. 700/286; 700/297

(57) ABSTRACT

Electrical power consumption is controlled and monitored by way of a wireless device interposed between the customer circuit and the electrical utility delivery system. The wireless devices is adapted to communicate with a central monitoring center by way of encoded SMS messages. The central monitoring center thereby receives consumption data at almost real time from the wireless device, without the common visit by the electrical utility agent. Furthermore, connection and disconnection of the customer circuit is facilitated by transmission of corresponding encoded SMS messages to the wireless device.

### CROSS-REFERENCE TO RELATED APPLICATION

This application is a continuation in part of, and claims priority from, U.S. patent application Ser. No. 10/916,174 entitled “Method and Apparatus for Communication with Remote Electronic Device” filed Aug. 11, 2004, now pending, which is incorporated herein by reference. This application also claims priority from Dominican Republic patent application no. P-2004/27/04/01 entitled “System for Remote Control of the Distribution of Electricity” filed Apr. 27, 2004, which is incorporated herein by reference.

### FIELD OF THE INVENTION

The present invention relates to communications systems and, in particular to interacting with Remote Electronic Devices by way of a central server.

### BACKGROUND

Electrical power distribution involves several control and monitoring elements. A utility controls delivery of electrical power to a customer by employing a switching unit installed at an entry point to the local customer circuit. The utility also monitors customer usage by a meter installed at the same entry point. As may be appreciated, the electrical utility has to send personnel to the location where the meter is installed to read level indications or otherwise configure the switching device for service activation or disconnect, an undertaking which involves significant time and effort. Moreover, breakdown or failure verification is usually detected only when it is reported by the customer rather than in a proactive manner.

This undertaking, not only due to the time needed to perform each task, but also due to the required management costs, is highly relevant to the financial bottom line of an electric or power company. Hence, minimization of costs associated with such tasks is highly desirable.

### SUMMARY

To overcome the limitations discussed above, the present invention provides a method and system for controlling and metering electrical usage by interposing an electronic device installed at the electrical entry point which communicated with a control center by way of a wireless cellular telephone network. The method further includes interposing an application server at the control center of the electrical utility to allow for exchange of data and commands with the intelligent meters. In another embodiment, the invention provides a control system for controlling and adjusting autonomous remote electronic meters via a localized central server. The invention ensures a reliable and robust communication session by employing intelligent command processing by the application server at the control center to ensure that the electronic device reliably receives and transmits data.

The electrical service control system of the invention includes a control center, a central application server and the plurality of intelligent meters. The system provides a control channel by which a complete automatization application manages the services related to the electrical utility. The system improves productivity for the electric utility. Specifically, through the centralized control of processes, it is possible to remotely and instantly manage a wide array of functions, eliminating high costs associated with operation logistics, and improving the overall quality of service as well as customer satisfaction. The system of the present invention greatly simplifies the performance of extremely complex tasks by converting those tasks to activities as simple as accessing a computer to receive data from an intelligent meter.

### BRIEF DESCRIPTION OF THE DRAWINGS

FIG. 1 illustrates the geographical location and interaction between logical elements in an example system;

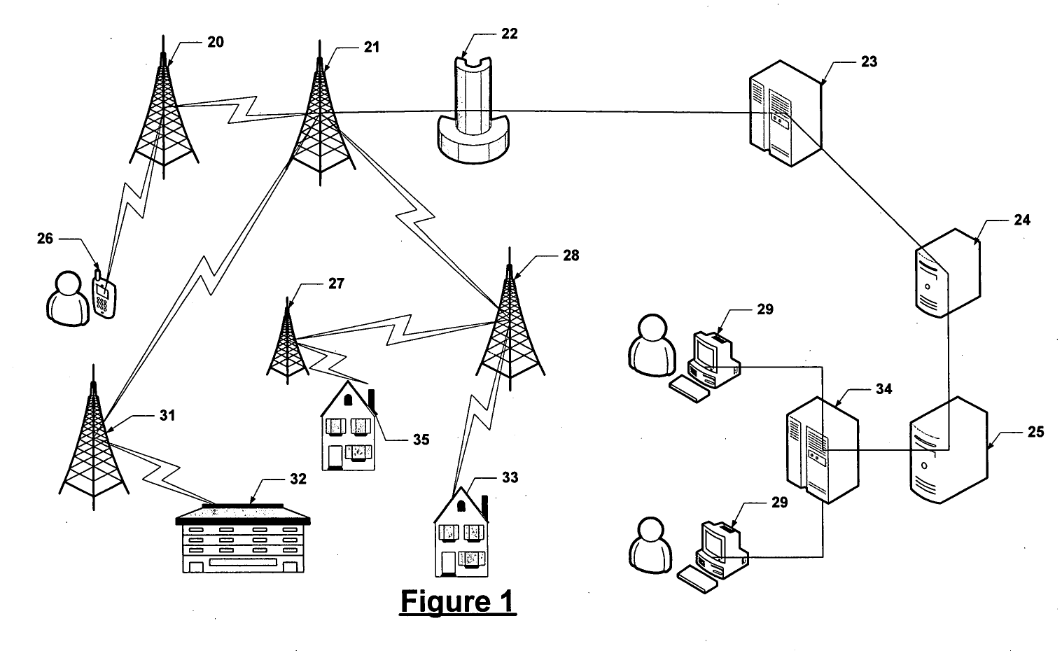

FIG. 2 illustrates the logical components associated with an application server associated with a wireless carrier processing commands in a system of the invention;

FIG. 3 illustrates data flow between logical components in the application server of FIG. 2 when processing user commends;

FIG. 4 illustrates data flow between logical components in the application server of FIG. 2 when processing device messages; and

FIG. 5 is a flow diagram illustrating the operation of a message translation module of the application server.

### DETAILED DESCRIPTION

The present invention facilitates robust communication between an electric utility and intelligent meters at customer locations by providing an application server at a utility's control center. The electric utility includes a control server that communicates commands to the application server. The application server transmits a command to a remote intelligent meter by converting the command to a Short Message System (SMS) message. The application server preferably has SMS transmission capability to transmit and receive a byte sequence or alphanumeric characters over a wireless communication protocol. The alphanumeric character SMS format provides a command set which is specific to the intelligent meters. The command includes a configuration function which manages adjustments of the intelligent meter's operational parameters as well as a command function for operational instructions. The application server of the invention is adapted to receive a command from the control server. The application server responds by processing, verifying, authorizing and deploying the command as well as optionally providing a message indicating the execution status.

As may be appreciated from the discussion below, the present invention provides a centralized system for the remote control and monitoring of electrical usage by a utility or other power distributor, for both residential and industrial customers. Generally, the system includes a plurality of electronic devices controlled remotely by means of SMS messages. A software platform, or API, is preferably used for monitoring as well as instructions such as measuring, disconnect, reconnect, and failure detection. The functions may also include monitoring variations in voltage or frequency at the entry point so as to preemptively detect faults in service.

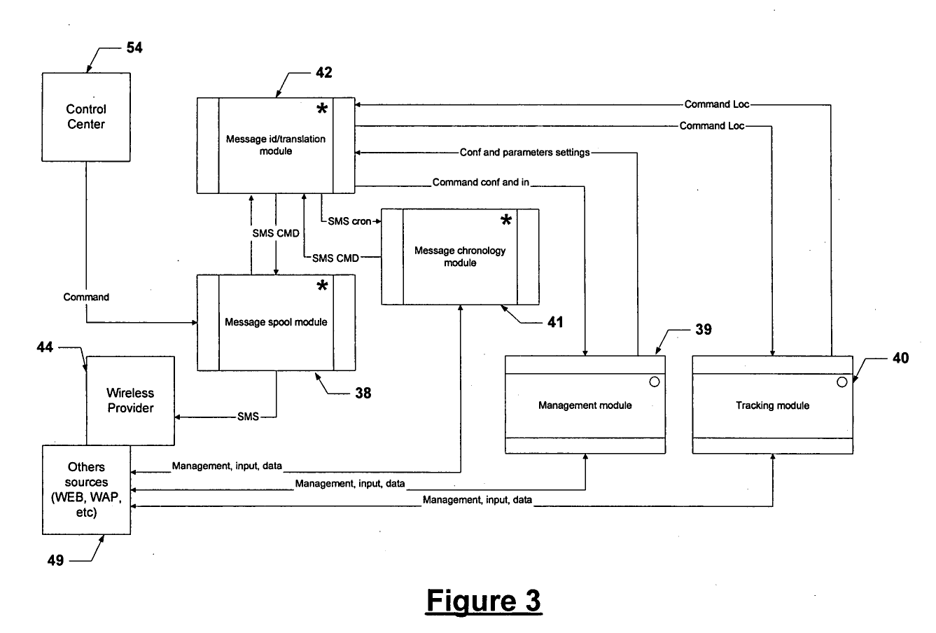

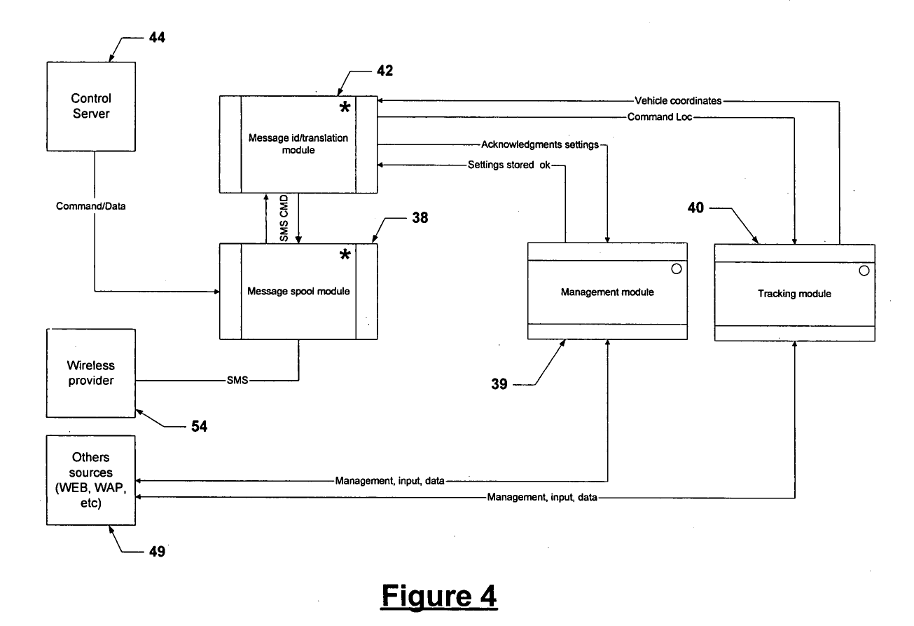

In operation, a command from the control center is facilitated by the transmission of SMS messages to the intelligent meter at the consumer location after some processing by the application server at the wireless carrier. A first processing flow is provided for processing commands received from the control center (FIG. 3). A second, reverse, processing flow is provided for processing data received from the intelligent meters (FIG. 4).

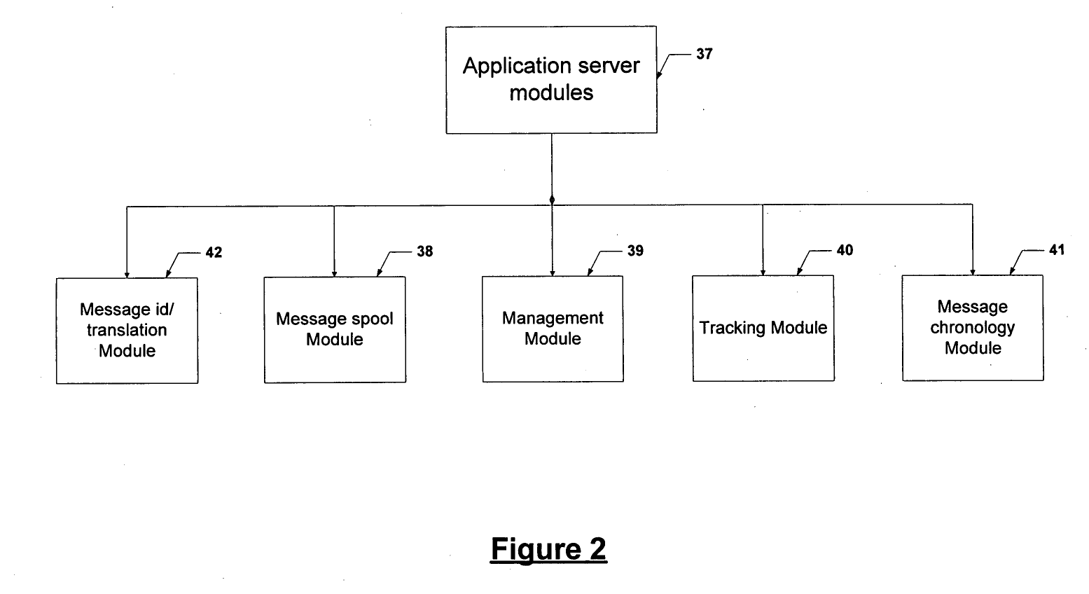

FIG. 2 illustrates logical components associated with an application server 25 of the invention. The components may be facilitated by software programs running on one or several computer systems. The components are discussed below as independent software modules. However, as may be appreciated, two or more of the modules can be combined depending on the particular implementation platform employed. The discussion below further presumes that the application server has access to an SMS generation and transmission module. In one embodiment, the application server is coupled to a wireless carrier by a network link, such as over the internet. In another embodiment, the application server is coupled to a wireless transmitter for sending the SMS format commands to the intelligent meters by way of the wireless carrier.

A main server module component 37 serves to integrate the various components so as to facilitate transmission of data between components. The main server module 37 also facilitates invocation of tasks to be executed by one or more component, as applicable to a desired procedure.

A translation module 42 is provided to facilitate proper formatting of the SMS messages transmitted instructions to the intelligent meters. The translation module 42 generally receives commands from the control center or data messages from the intelligent meters. The translation module 42 then generates one or more messages to be delivered to the control center so as to execute the desired command or convey the intelligent meter data. In one embodiment, the translation module 42 identifies the message type prior to initiating processing. The message translation module 42 applies a translation algorithm to the received message so as to facilitate proper processing. Employing a proper translation algorithm allows the translation module 42 to format and execute commands in accordance with the particular message type.

A message spool module 38 provides messages for transmission by the wireless carrier. The message spool module 38 preferably stores messages, which are generated by the message translation module for transmission to the control center or to the intelligent meters.

A management module 39 facilitates configuration of the intelligent meters by reference to a configuration database. The management module 39 allows the application server 25 to initialize each intelligent meter with a corresponding set of parameters as provided by the control center administrator. Example initialization parameters include: [Add parameters]

A tracking module 40 facilitates geographical location identification functions to receive location data for the intelligent meters. Such tracking is provided by employing known algorithms which would be apparent to one of ordinary skill in the art.

A message chronology module 41 facilitates scheduling of message transmission to the intelligent meters. The application server 25 employs the message chronology module 41 to transmit commands to the message spool module 38 for recurring tasks, or schedules tasks, such as monthly usage readings.

FIG. 3 illustrates data paths between the logical modules of FIG. 2 when the application server 25 is processing a command from the control center. The command is preferably in the form of a function call from an API of the application server which was made available to the control center.

An SMS message is received by the message spool module 38 to identify the intelligent meter or set of devices to which the message is directed by reference to a target identifies. The SMS message is provided to the translation module 42 for processing. The translation module 42 employs a translation database (not shown) to determine the appropriate processing for the command. If the command requires location tracking, the translation module 42 forwards the location tracking command to the tracking module 40. The tracking module facilitates device tracking by employing external modules 49, such as for example GSM Cell Network Information processing module, CDMA Cell Network Information processing module, and a GPS Network Information processing module. If commands are to be provided to an intelligent meter as part of the tracking process, the tracking module 40 provides such commands to the message spool system by way of the translation module 42. If the command is for modifying configuration parameters of the intelligent meter device, the translation module forwards the configuration command to the management module 39. The management module 39 processes configuration commands in accordance with stored data and data acquired from external sources 49 such as the control center, the control center database, and the intelligent meter. If the command is a request to schedule a future command, the translation module 42 forwards the command to the message chronology module 41. In one embodiment, the message chronology module 41 stores the command in a transmission queue to provide a future SMS message to the intelligent meter.

When the message chronology module 41 determines that a command should be transmitted to an intelligent meter, in accordance with stored database data providing command schedules, the module provides at least one command to the translation module 42.

Once the translation module 42 has completed the processing of a command, at least one resultant SMS message is provided to the message spool module 38 for transmission to the intelligent meter. The message spool module 38 also stores status messages that are to be directed to control center.

FIG. 4 illustrates data paths between the logical modules of FIG. 2 when the application server 25 is processing data received from the intelligent meters. An intelligent meter transmits an SMS message to the application server 25 by employing a wireless transmission module. As may be appreciated, the intelligent meter generally includes a processor for controlling various system operations as well as a wireless transmission module to facilitate communication of SMS messages to the application server 25. Details relating to the specific structure of the intelligent meter are not essential for the description of the present invention and would be apparent to one of ordinary skill in the art. In one embodiment of the intelligent meter is battery operated. The intelligent meter may also include a tamper alarm function.

The message spool module 38 processes the received SMS message to provide a proper response to either the control center or one of the application server modules. To facilitate proper processing, each such response data is preferably formatted in a predetermined form, which includes data identifying the response as directed to one of the several application server modules. When the intelligent meter message is in response to a location function request, the response location data is provided to the tracking module 40. In some states of the application server 25, the tracking module 40 responds to the location data with a reply command or acknowledgement. In some embodiments, the tracking module 40 employs external data sources 49 in processing the location data. Such external sources include the sources discussed above with respect to the tracking module 40 location command processing. When the message is in response to a configuration command, the message data is provided to the management module 39. The message is then processed by the management module 39, with or without reference to the external sources 49 discussed above. In some states of the application server 25, a response indication is transmitted to the translation module 42 for delivery to the control center.

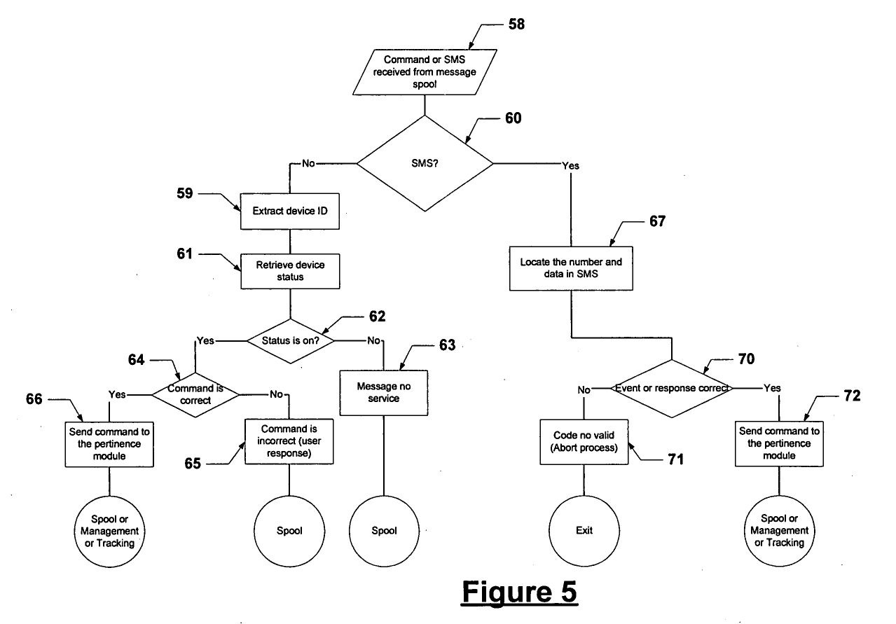

FIG. 5 is a flow diagram illustrating the operation of the translation module 42. An SMS message is received from the spool module originating either from an intelligent meter (Step 58). The translation module extracts both the address identifier from the SMS as well as the associated message data (Step 59). As discussed above, the address identifier is an identifier that is associated with each intelligent meter. The translation module determines whether the event or response encoded in the SMS message is correct (Step 70), by reference to registered model and version identifier for the intelligent meter, and the predefined format in which it is registered to send data, as well as well known mechanisms, such as cyclic redundancy check, and transaction specific identifiers. If the command is correct the translation module sends the command to the appropriate module for processing (Step 72). If the command is not correct, the translation module aborts the process and returns a notification to the control center and the fault data is recorded (Step 71). If the translation module is not able to retrieve the meter record, the process is aborted since no meter is properly associated with the message and the fault data is recorded (Step 69).

The translation module processes a command directed to an intelligent meter by searching for data record associated with the meter (Step 61). If a record is not located, the translation module generates a no service message and provides the message to the spool module for transmission to the source of the command (Step 63). If a record is retrieved for the intelligent meter, the translation module determines whether the command is correct by reference to the procedure described above (Step 64). If the command is correct, the translation module transmits the command data to the appropriate module associated with the command as discussed above with reference to FIG. 3 (Step 66). If the command is incorrect, the translation module generates an error message and provides the message to the spool module for transmission to the source of the command (Step 65).

The application server allows for a vertical configuration of functions over consumption reports, consumption regulation, and consumer payment notifications by communicating with the remote devices over a wireless connection. Furthermore, metered information is retrieved in an immediate and instantaneous manner by transmitting corresponding queries to the intelligent meters. The application server is adapted to communicate with the billing system of the electrical utility, allowing for versatility and time savings in obtaining required data.

Some of the issues addressed by the present system include the high operation costs involved in managing logistics during readings of meters, disconnection and reconnection of the electric service, failure/breakdown verification and detection, and generating reliable client consumption reports. The system also reduces reaction time and execution of tasks when personnel should be dispatched. Additionally, the system allows for efficient management of resources and almost real-time data relating to each consumer circuit's status. Other efficiencies are provided by reducing human errors in readings and loss of precision between employees. The present system may also serve to reduce fraud in the power lines. The present invention also greatly simplifies the monthly billing process. Customer consumption levels are rapidly queried by the application server by way of the remote intelligent meter to provide data for a billing application of the utility. Accordingly, the invention provides substantial cost reduction to the electrical utility. Also, of equal importance to the utility is the capacity to disconnect and reconnect the electrical service when necessary by transmitting a corresponding command to the intelligent meter.

The application server may also preemptively detect minor faults in the electrical flow, which may cause a service interruption prior to the interruption occurring, thus avoiding the need to wait for the interruption to occur, or even for the customer to become aware of the minor problem. Accordingly the intelligent meter detects variations in voltage, frequency, power factor, and consumption level in accordance with predetermined parameters, indicating which variations should be reported.

In some embodiments the application server includes a graphic software interface that facilitates additional control and manipulation of the remote intelligent meters. The application preferably has access to the remote intelligent meters and is integrated with a geographic database providing location information for the remote intelligent meters to facilitate access to and execution of diverse tasks.

The application server is preferably configured to provide functionality to address concerns that are specific to each utility. The functions can be adapted to cover the requirements of the utility without the need to replace or modify applications employed by the utility to control logistics and operations.

The application server may be configured to request consumption and reading information at a predetermined frequency. At the same time, the intelligent meters send alarms with anomalies related to voltage, frequency, power factor, consumption levels, and manipulations. The information is then provided to the control server by way of the application server. The control center then determines how to proceed in view of each failure. After the system is integrated into the electric utility, the application server can be used to manipulate all functions associated with the intelligent meter.

In one embodiment, the utility's billing computer directly solicits consumption data or is programmed so that the application server automatically delivers to the application server data. Preferably the intelligent meter sends data to the application server after a request is received and processed by the intelligent meter. Thereafter, the billing computer can proceed to generate invoices and reports from the required data.

Although the present invention was discussed in terms of certain preferred embodiments, the invention is not limited to such embodiments. A person of ordinary skill in the art will appreciate that numerous variations and combinations of the features set forth above can be utilized without departing from the present invention as set forth in the claims. Thus, the scope of the invention should not be limited by the preceding description but should be ascertained by reference to claims that follow.

1. A method for controlling and monitoring electrical usage by an electric utility, comprising:
providing an intelligent meter at a customer location, the intelligent meter including a wireless SMS reception and transmission module;
a server of the electrical utility transmitting a command to a communication module, the command is for controlling and monitoring electrical usage;
the communication module processing the command to provide at least one SMS message;
the communication module transmitting the SMS message to the a intelligent meter; and
the remote module processing the SMS to control a local electrical supply function.

2. The method of claim 1, further comprising the intelligent meter transmitting a response to the communication module.

3. The Method of claim 2 wherein said response provides an indication of a consumption level.

4. The method of claim 1, wherein the command is transmitted to the communication module as e-mail message text.

5. The method of claim 1, wherein the command is transmitted to the communication module by a computer coupled to the internet.

6. The method of claim 1, wherein the command is transmitted to the communication module by a user device mobile telephone employing a mobile network.

7. The method of claim 1, wherein the communication module is provided at a wireless carrier location.

8. The method of claim 1, wherein the communication module is on the same LAN as an SMS module of a wireless carrier which is used to transmit the SMS message to the remote module.

9. The method of claim 1, wherein the communication module provides a plurality of SMS messages by reference to a single command.

10. The method of claim 1, wherein the transmission of SMS is over wireless network.

11. The method of claim 1, further including the communication module receiving a command from an automatic module transmitting commands according to schedule.

12. The method of claim 1, further including queuing a preference database for intelligent meter configuration data.

13. The method of claim 1, further including employing SMS message to configure operation of the intelligent meter.

14. The method of claim 1, further including receiving status data as part of SMS message text received from the intelligent meter.

15. The method of claim 1 wherein the communication module is coupled to the billing and service center of the electric utility.

16. The method of claim 1 wherein the command is for an operation from the group consisting of remote electric reading, consumption, disconnection and reconnection of service, voltage variation, frequency, power factor, alteration to the meter operation, and programming of future tasks.

17. The method of claim 2 wherein the response includes data related to a level of electrical consumption and state of such consumption.

18. The method of claim 1 wherein the communication module is integrated with a wireless carrier.

19. The method of claim 1 wherein the intelligent meter temporarily stores usage readings in a local memory.
